(19) United States
(12) Patent Application Publication
(10) Pub. No.: US 2014/0184610 A1
(43) Pub. Date: Jul. 3, 2014

(54) SHAPING DEVICE AND SHAPING METHOD

(71) Applicant: KABUSHIKI KAISHA TOSHIBA, Tokyo (JP)

(72) Inventors: Tomoyuki Shibata, Kawasaki-shi (JP); Yasunobu Yamauchi, Yokohama-shi (JP); Kazunori Imoto, Kawasaki-shi (JP)

(73) Assignee: KABUSHIKI KAISHA TOSHIBA, Tokyo (JP)

(21) Appl. No.: 14/107,076

(22) Filed: Dec. 16, 2013

(30) Foreign Application Priority Data
Dec. 27, 2012 (JP) 2012-286048

(51) Int. Cl. G06T 11/20

(52) U.S. Cl. CPC G06T 11/20
USPC 345/441

(57) ABSTRACT

According to an embodiment, a shaping device includes one or more processors and a display. the one or more processors configured to acquire data handwritten by a user. the one or more processors configured to divide the data into a plurality of structures. the one or more processors configured to determine a shaping mode for each of the plurality of structures. the one or more processors configured to shape the plurality of structures in the shaping mode determined for each of the plurality of the structures. the display configured to display a result of shaping each of the plurality of structures.

### CROSS-REFERENCE TO RELATED APPLICATION

This application is based upon and claims the benefit of priority from Japanese Patent Application No. 2012-286048, filed on Dec. 27, 2012; the entire contents of which are incorporated herein by reference.

### FIELD

An embodiment described herein relates generally to a shaping device and a shaping method.

### BACKGROUND

There are technologies for determining whether handwritten data input by a user is data of characters or data of a graphic, and switching the method for editing the handwritten data according to the determination result.

With the aforementioned technologies of the related art, however, if the user inputs handwritten data containing a combination of multiple types of data such as characters and graphics, the handwritten data cannot be properly shaped. An object to be achieved by the present invention is to provide a shaping device, a method therefor and a program therefor capable of properly shaping handwritten data containing a combination of multiple types of data.

### BRIEF DESCRIPTION OF THE DRAWINGS

FIG. 1 is a configuration diagram illustrating an example of a shaping device according to an embodiment;

FIG. 2 is a diagram illustrating an example of handwritten data according to the embodiment;

FIG. 3 is a diagram illustrating an example of a result of dividing the handwritten data according to the embodiment;

FIG. 4 is a diagram illustrating an example of a result of shaping in a graphic shaping mode according to the embodiment;

FIG. 5 is a diagram illustrating an example of a result of shaping in a mathematical expression shaping mode according to the embodiment;

FIG. 6 is a diagram illustrating an example of a structure of a group of strokes constituting handwritten characters according to the embodiment;

FIG. 7 is a diagram illustrating an example of a result of shaping in a character shaping mode according to the embodiment;

FIG. 8 is a graph illustrating an example of classification of a rule stroke according to the embodiment;

FIG. 9 is a diagram illustrating an example of classification of a rule stroke according to the embodiment;

FIG. 10 is a diagram illustrating an example of a result of classification of a group of strokes constituting a handwritten table according to the embodiment;

FIG. 11 is a diagram illustrating an example of a result of identifying regions in a handwritten table according to the embodiment;

FIG. 12 is a diagram illustrating an example of a result of determining rule strokes according to the embodiment;

FIG. 13 is a diagram illustrating an example of a result of shaping in a table shaping mode according to the embodiment;

FIG. 14 is a diagram illustrating an example of display of a shaping result according to the embodiment;

FIG. 15 is a flowchart illustrating an example of a shaping process according to the embodiment;

FIG. 16 is a flowchart illustrating an example of a re-shaping and output process according to the embodiment;

FIG. 17 is a diagram illustrating an example of selection of a part according to a modification 1; and

FIG. 18 is a diagram illustrating an exemplary hardware configuration of a shaping device according to the embodiment and the modifications.

### DETAILED DESCRIPTION

According to an embodiment, a shaping device includes one or more processors and a display. the one or more processors configured to acquire data handwritten by a user. the one or more processors configured to divide the data into a plurality of structures. the one or more processors configured to determine a shaping mode for each of the plurality of structures. the one or more processors configured to shape the plurality of structures in the shaping mode determined for each of the plurality of the structures. the display configured to display a result of shaping each of the plurality of structures.

An embodiment will be described below in detail with reference to the accompanying drawings.

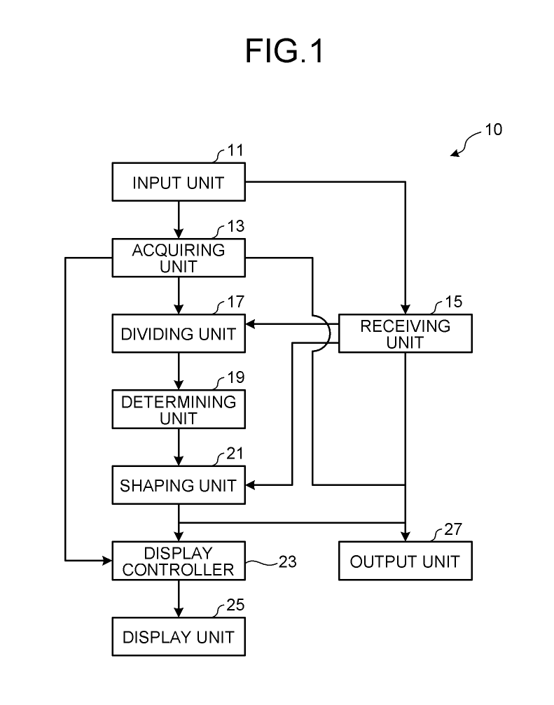

FIG. 1 is a configuration diagram illustrating an example of a shaping device 10 according to an embodiment. As illustrated in FIG. 1, the shaping device 10 includes an input unit 11, an acquiring unit 13, a receiving unit 15, a dividing unit 17, a determining unit 19, a shaping unit 21, a display controller 23, a display unit 25, and an output unit 27.

The input unit 11 can be realized with an input device allowing handwritten input such as a touch panel, a touch pad, a mouse, and an electronic pen. The acquiring unit 13, the receiving unit 15, the dividing unit 17, the determining unit 19, the shaping unit 21, the display controller 23, and the output unit 27 may be implemented by making a processor such as a central processing unit (CPU) execute a program, that is, by software, may be implemented by hardware such as an integrated circuit (IC), or may be implemented by combination of software and hardware, for example. The display unit 25 can be realized with a display device such as a touch panel display or a liquid crystal display, for example.

The input unit 11 inputs handwritten data that is data of characters, graphics, tables, mathematical expressions, or the like handwritten by a user to the shaping device 10. In the embodiment, it is assumed that the input unit 11 is a touch panel and that the user inputs handwritten data by handwriting characters, graphics, tables, mathematical expressions, or the like on the touch panel with a stylus pen or a finger, but the input unit 11 is not limited thereto. For example, the input unit 11 may be realized with a touch pad, a mouse or an electronic pen.

The handwritten data is composed of a set of strokes. A stroke is data representing one unit of a character, a graphic, a table, a mathematical expression, or the like handwritten by the user, that is, a trajectory of a stylus pen or a finger from where the pen or the finger touches an input face of the touch panel to where the pen or the finger gets away therefrom (from pen down to pen up). A stroke is expressed as time series coordinate values of a contact point of the stylus pen or the finger with the input face such as {(x₁, y₁), (x₂, y₂), . . . , (xₙ, yₙ)}.

The input unit 11 also inputs various instructions such as an instruction to shape input handwritten data, an instruction to re-shape handwritten data, an instruction to output a file of shaped data resulting from shaping or re-shaping handwritten data, an instruction to cancel output of a file of shaped data, and an instruction to output a file of handwritten data to the shaping device 10.

Although it is assumed in the present embodiment that the input unit 11 also inputs these various instructions, the manner in which various instructions are input is not limited thereto. For example, the shaping device 10 may further include an input unit such as an operator different from the input unit 11 and this input unit may input various instructions mentioned above.

The acquiring unit 13 acquires handwritten data input by the input unit 11. Specifically, the acquiring unit 13 acquires handwritten data by sequentially acquiring strokes input by the input unit 11.

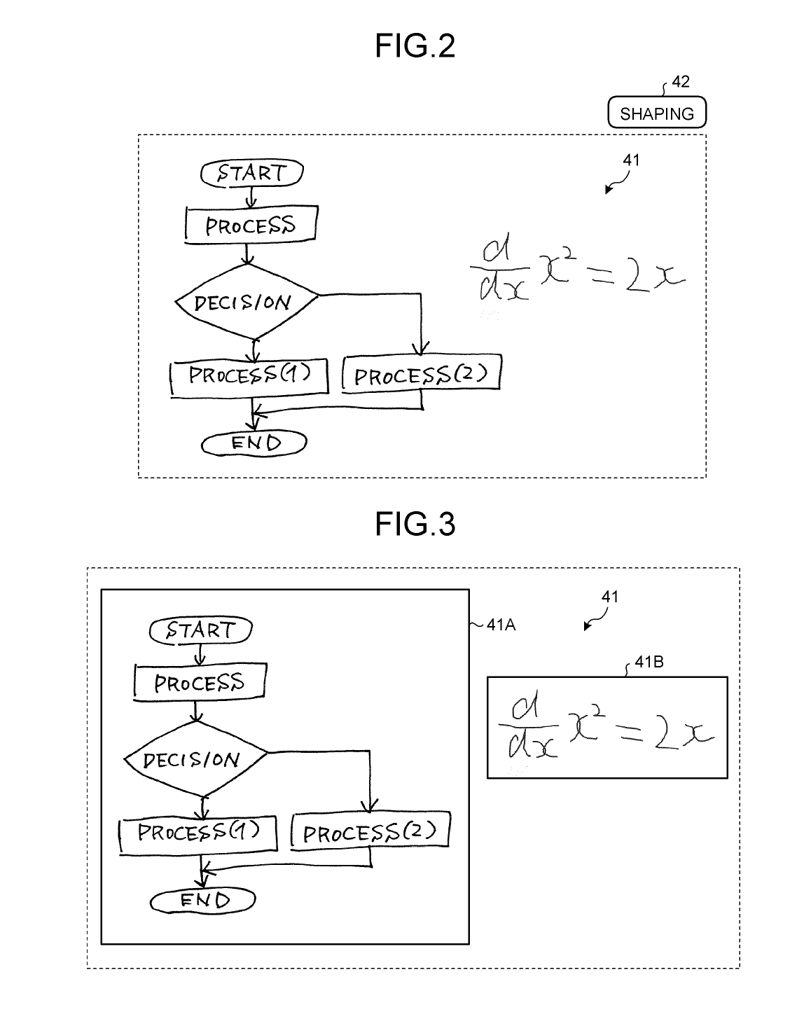

FIG. 2 is a diagram illustrating an example of handwritten data according to the embodiment. In the example illustrated in FIG. 2, handwritten data 41 contains a handwritten graphic that is a flowchart handwritten by the user and a handwritten mathematical expression that is an expression handwritten by the user. Although detailed description will not be made, it is assumed in the embodiment that, once the handwritten data input from the input unit 11 is acquired by the acquiring unit 13, coordinate values of the strokes are linearly compensated and the resulting handwritten data is displayed on the display unit 25. In the example illustrated in FIG. 2, the handwritten data 41 displayed on the display unit 25 is illustrated with a shaping button 42. Note that the format in which a menu screen such as the shaping button 42 is displayed is not limited thereto, but various display formats such as icons or texts may be employed.

Although handwritten data containing a handwritten graphic and a handwritten mathematical expression is assumed in the following description, the handwritten data is not limited thereto and may be any data containing at least two of handwritten characters, a handwritten graphic, a handwritten table, a handwritten mathematical expression, and the like.

The receiving unit 15 (an example of a first receiving unit and a second receiving unit) receives various instructions input by the input unit 11. For example, in the example illustrated in FIG. 2, when the shaping button 42 is touched, the input unit 11 inputs an instruction to shape the handwritten data 41 and the receiving unit 15 receives the shaping instruction.

The dividing unit 17 divides handwritten data acquired by the acquiring unit 13 into a plurality of structures. Specifically, when an instruction to shape handwritten data is received by the receiving unit 15, the dividing unit 17 structures the handwritten data (set of strokes) into multiple groups of strokes according to relative positions of respective strokes constituting the handwritten data acquired by the acquiring unit 13.

More specifically, the dividing unit 17 calculates the likelihood for each of the strokes constituting the acquired handwritten data, expresses the likelihoods in a Markov random field (MRF) so as to add spatial proximity and continuity on a coordinate plane, and estimates a plurality of divided regions into which a region where the handwritten data is present is divided and which can be most easily separated (refer, for example, to Xiang-Dong Zhou, Cheng-Lin Liu, “Text/Non-text Ink Stroke Classification in Japanese Handwriting Based on Markov Random Fields,” Document Analysis and Recognition, 2007, ICDAR 2007, Ninth International Conference on, 23-26 Sep. 2007). The dividing unit 17 then structures one or more strokes present in each of the regions resulting from the division into a group of strokes. In this manner, the dividing unit 17 divides the handwritten data (set of strokes) into multiple structures (groups of strokes).

FIG. 3 is a diagram illustrating an example of a result of dividing the handwritten data according to the embodiment. In the example illustrated in FIG. 3, the handwritten data 41 is divided into a structure 41A resulting from structuring a group of strokes constituting a handwritten graphic and a structure 41B resulting from structuring a group of strokes constituting a handwritten mathematical expression.

The determining unit 19 determines a shaping mode for each of the multiple structures obtained through the division by the dividing unit 17. Specifically, the determining unit 19 extracts a feature quantity from each of the strokes constituting a structure, identifies the extracted feature quantities by each of multiple discriminators provided for respective shaping modes, and calculates the likelihood of each stroke for each shaping node. The determining unit 19 then adds the calculated likelihoods of the strokes for each shaping mode, and determines a shaping mode with the largest sum of likelihoods as the shaping mode for the structure. Each of the multiple discriminators has learned in advance typical formats associated with the shaping modes.

In the embodiment, it is assumed that examples of the shaping modes include a character shaping mode in which handwritten characters are shaped, a graphic shaping mode in which handwritten graphics are shaped, a table shaping mode in which handwritten tables are shaped, and a mathematical expression shaping mode in which handwritten mathematical characters are shaped, but the shaping modes are not limited thereto. Note that handwritten graphics need not contain only handwritten graphics but may contain handwritten graphics and handwritten characters. Similarly, handwritten tables need not contain only handwritten tables but may contain handwritten tables and handwritten characters.

Note that there tends to be a high proportion of short and linear strokes when handwritten data is composed of handwritten Kanji characters, that there tends to be a high proportion of curved strokes when handwritten data is composed of handwritten Kana or alphabetic characters, and that there tends to be a high proportion of linear strokes when handwritten data is composed of handwritten graphics.

Accordingly, a shaping mode according to the structure (which of handwritten characters, a handwritten graphic, a handwritten table, and a handwritten mathematical expression the group of strokes in the structure composes) by the method for determining the shaping mode described above.

The determining unit 19 preferably determines the shaping mode in descending order of the areas of the multiple structures obtained through the division by the dividing unit 17. If the sum of the likelihoods for the shaping mode with the largest sum is smaller than a threshold, the determining unit 19 may perform the determination of the shaping mode described above again. In this case, the determining unit 19 need not perform the determination of the shaping mode again on all the structures but may perform the determination of the shaping mode again on a next largest structure among the structures. If the largest total of the likelihoods reaches the threshold, the determining unit 19 then determines the shaping mode having the largest total of the likelihoods, or if the largest total of the likelihoods is smaller than the threshold, the determining unit 19 may then repeat the same processing.

The shaping unit 21 shapes each of the structures obtained through the division by the dividing unit 17 in the shaping mode determined by the determining unit 19. Specifically, the shaping unit 21 performs recognition on a group of strokes constituting each of the structures obtained through the division by the dividing unit 17 in the shaping mode determined by the determining unit 19 to assign a character code, vector data, image data, or the like corresponding to the group of strokes to character strokes constituting a character, graphic strokes constituting a graphic, or the like in the group of strokes. The shaping unit 21 then converts the character strokes or the graphic strokes in the group of strokes into the assigned character code or vector data. For example, the shaping unit 21 shapes handwritten data by performing the shaping described above on each of the structures obtained through the division by the dividing unit 17.

When a structure (a group of strokes constituting a handwritten graphic) is to be shaped in the graphic shaping mode, for example, the shaping unit 21 performs pattern matching for graphic recognition between each of graphic strokes in the group of strokes and standard patterns of strokes by using dictionary data in which vector data or image data of graphics and standard patterns of strokes corresponding to the data are defined in association with one another. The shaping unit 21 then assigns vector data or image data associated with the matched standard pattern to each of the graphic strokes in the group of strokes, and converts each of the character strokes in the group of strokes into the assigned vector data or image data.

Note that, since strokes that are not matched in the pattern matching for graphic recognition are highly likely to be character strokes rather than graphic strokes, the shaping unit 21 performs pattern matching for character recognition on these strokes.

For example, the shaping unit 21 performs pattern matching for character recognition between each of character strokes in the group of strokes and standard patterns of strokes by using dictionary data in which character codes and standard patterns of strokes corresponding to the character codes are defined in association with one another. The shaping unit 21 then assigns the character code associated with the matched standard pattern to each of the character strokes in the group of strokes, and converts each of the character strokes in the group of strokes into the assigned character code.

In order to increase the recognition accuracy of pattern matching, multiple standard patterns associated with one character code may be provided, and the shaping unit 21 may calculate the distances between endpoints of strokes included in strokes of standard patterns and the distances between endpoints of strokes included in character strokes and use the calculated distances for pattern matching.

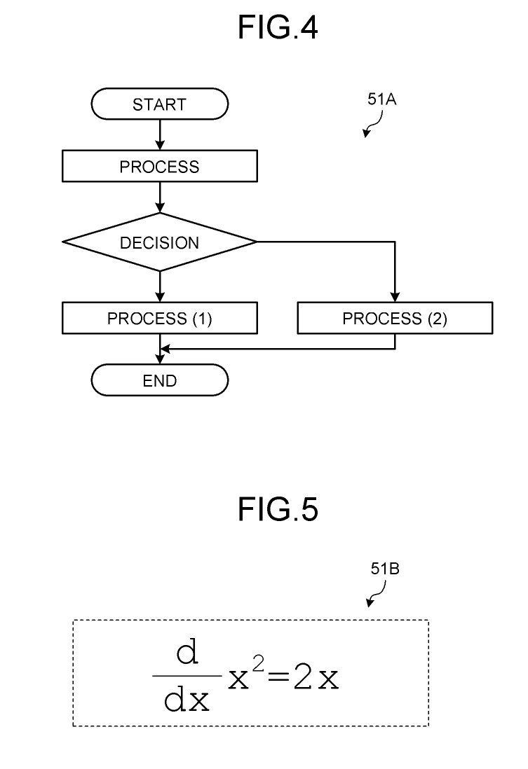

FIG. 4 is a diagram illustrating an example of a result of shaping in the graphic shaping mode according to the embodiment. In the example illustrated in FIG. 4, the structure 41A (see FIG. 3) resulting from structuring a group of strokes constituting a handwritten graphic (a flowchart handwritten by the user) is shaped into a flowchart 51A expressed by vector data and character codes.

Alternatively, when a structure (a group of strokes constituting a handwritten mathematical expression) is to be shaped in the mathematical expression shaping mode, for example, the shaping unit 21 assigns a character code for mathematical expressions to each of character strokes for mathematical expressions in the group of strokes on the basis of stroke likelihoods and structure likelihoods (for example, a maximum value of products of the stroke likelihoods and the structure likelihoods). A stroke likelihood is obtained by pattern matching for character recognition as described above and refers to the probability that a character stroke for mathematical expressions corresponds to a matched standard pattern. A structure likelihood refers to the probability that a structure corresponds to the structure expressed by a group of strokes, such as the probability that a structure “−|” is “−1” or the probability that the structure “−|” is “+”. Structure likelihoods can be modeled by a stochastic context-free grammar (SCFG), for example. The shaping unit 21 then converts each of the character strokes for mathematical expressions in the group of strokes into the assigned character code for mathematical expressions.

FIG. 5 is a diagram illustrating an example of a result of shaping in the mathematical expression shaping mode according to the embodiment. In the example illustrated in FIG. 5, the structure 41B (see FIG. 3) resulting from structuring a group of strokes constituting a handwritten mathematical expression is shaped into a mathematical expression 51B expressed by character codes for mathematical expressions.

Alternatively, when a structure (a group of strokes constituting handwritten characters) is to be shaped in the character shaping mode, for example, the shaping unit 21 assigns a character code associated with the matched standard pattern to each of character strokes in the group of strokes by the pattern matching for character recognition described above, and converts each of the character strokes in the group of strokes into the assigned character code.

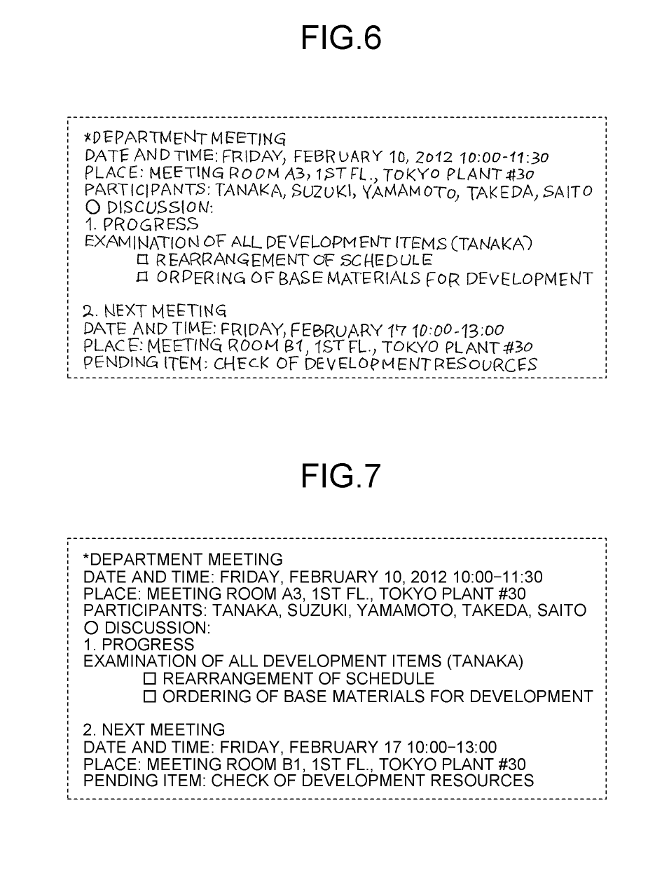

FIG. 6 is a diagram illustrating an example of a structure obtained by structuring a group of strokes constituting handwritten characters according to the embodiment, and FIG. 7 is a diagram illustrating an example of a result of shaping in the character shaping mode according to the embodiment. In the example illustrated in FIG. 7, the structure (see FIG. 6) resulting from structuring a group of strokes constituting handwritten characters is shaped into characters (document) expressed by character codes.

Alternatively, when a structure (a group of strokes constituting a handwritten table) is to be shaped in the table shaping mode, for example, the shaping unit 21 first analyzes the strokes in the group of strokes to classify the strokes into rule strokes and the other strokes.

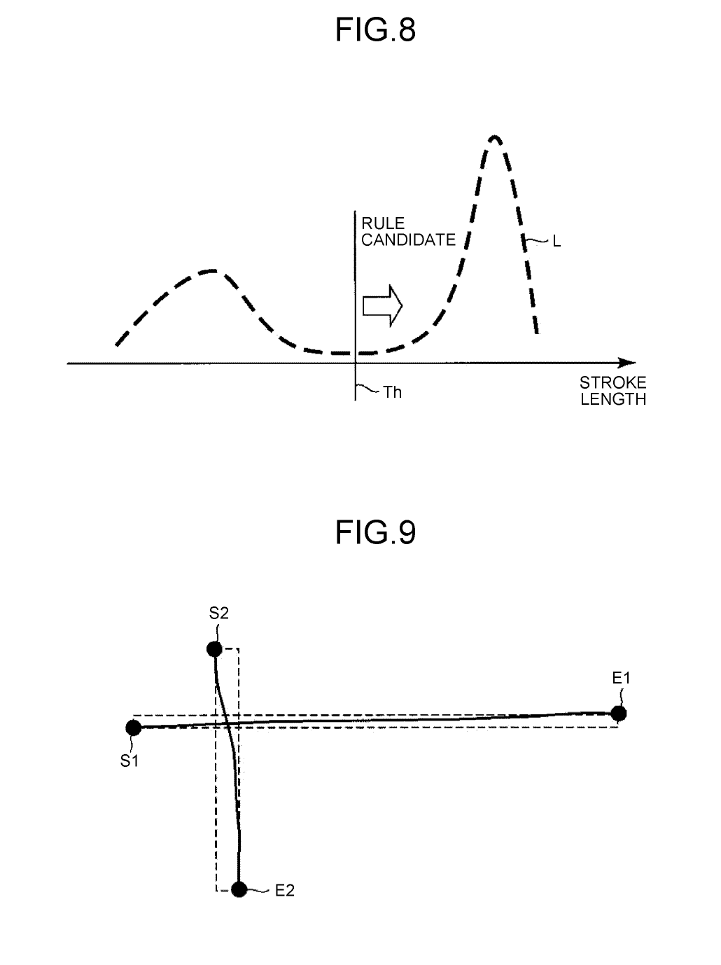

Note that a rule of a table tends to have a relatively large stroke length and an extremely large or small aspect ratio of vertical and horizontal lengths determined by start and end endpoints of the stroke. Thus, the shaping unit 21 classifies a stroke having a stroke length larger than a threshold Th in a histogram L of the stroke length as illustrated in FIG. 8 as a rule stroke, for example. The shaping unit 21 also classifies a stroke having an extremely large aspect ratio of vertical and horizontal lengths (a stroke having a start endpoint S1 and an end endpoint E1) and a stroke having an extremely small aspect ratio of vertical and horizontal lengths (a stroke having a start endpoint S2 and an end endpoint E2) as rule strokes as illustrated in FIG. 9, for example.

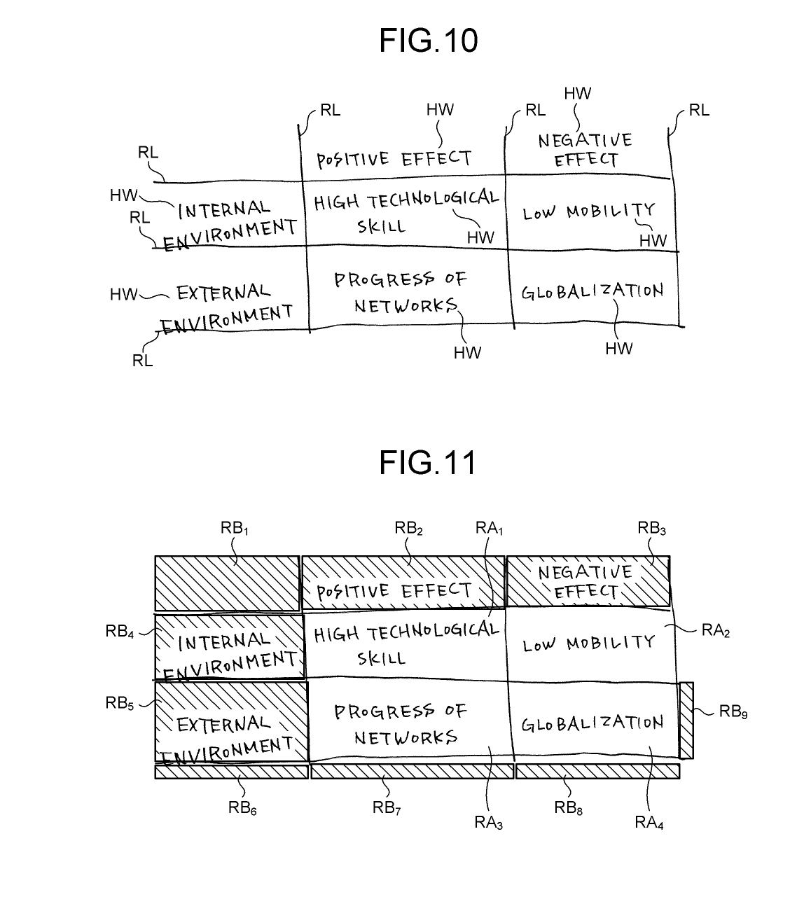

FIG. 10 is a diagram illustrating an example of a result of classification of a group of strokes constituting a handwritten table according to the embodiment. In the example illustrated in FIG. 10, a group of strokes constituting a handwritten table are classified as rule strokes RL and the other strokes (character strokes in the example illustrated in FIG. 10) HW.

Subsequently, the shaping unit 21 analyzes the classified rule strokes to identify the structure of the table such as the number or rows and the number of columns and identify regions (hereinafter may also be referred to as “cell regions”) surrounded by four intersections and regions (hereinafter may also be referred to as “non-cell regions”) not surrounded by four intersections. Note that the shaping unit 21 may identify regions containing at least one endpoint as non-cell regions and the other regions as cell regions.

FIG. 11 is a diagram illustrating an example of a result of identifying regions in a handwritten table according to the embodiment. In the example illustrated in FIG. 11, cell regions RA₁ to RA₄ and non-cell regions RB₁ to RB₉ are identified.

Subsequently, the shaping unit 21 determines whether or not rule strokes present in a non-cell region has a “small extension” projecting from an intersection or is to be supplemented with another rule stroke so as to form a table. For example, the shaping unit 21 determines whether or not the length of a rule stroke present in a non-cell region reaches a threshold based on a statistic calculated from multiple rule strokes present in non-cell regions, and determines that the rule stroke is a rule stroke to be supplemented with another rule stroke if the threshold is reached or determines that the rule stroke is a rule stroke with small extension if the threshold is not reached. For determination of a rule stroke present in a non-cell region, it is preferable that the shaping unit 21 provide a threshold for vertical rule strokes and a threshold for horizontal rule strokes and determine vertical rule strokes and horizontal rule strokes separately.

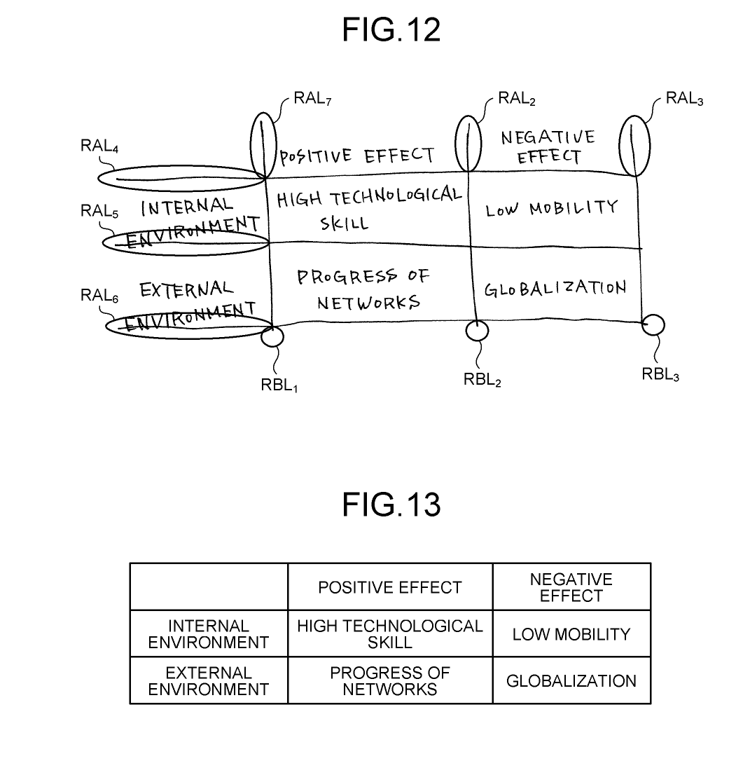

FIG. 12 is a diagram illustrating an example of a result of determining rule strokes present in non-cell regions according to the embodiment. In the example illustrated in FIG. 12, rule strokes RAL₂ to RAL₇ are those to be supplemented with new rule strokes while rule strokes RBL₁ to RBL₃ are those with small extensions.

Subsequently, the shaping unit 21 supplements the rule strokes to be supplemented with new rule strokes with the new rule strokes. For example, the shaping unit 21 supplements the rule strokes with vertical rule strokes connecting the endpoints of the rule strokes RAL₄ to RAL₆ and with horizontal rule strokes connecting the endpoints of the rule strokes RAL₂, RAL₃, and RAL₇ in the example illustrated in FIG. 12.

Subsequently, the shaping unit 21 performs pattern matching for table recognition between the rule strokes (including the supplemental rule strokes) in the group of strokes and standard patterns of strokes by using dictionary data in which rule data constituting tables and standard patterns of strokes corresponding to the rule data are defined in association with one another. The shaping unit 21 then assigns the rule data associated with the matched standard pattern to the rule strokes in the group of strokes, and converts the rule strokes in the group of strokes into the assigned rule data.

Since strokes other than the rule strokes in the group of strokes are highly likely to be character strokes, the shaping unit 21 performs pattern matching for character recognition described above on these strokes, assigns the character code associated with the matched standard pattern to each of the character strokes in the group of strokes, and converts each of the character strokes in the group of strokes into the assigned character code.

FIG. 13 is a diagram illustrating an example of a result of shaping in the table shaping mode according to the embodiment. In the example illustrated in FIG. 13, the structure (see FIG. 10) resulting from structuring a group of strokes constituting a handwritten table is shaped into a table expressed by rule data and character codes.

Note that the shaping unit 21 may change the layout and the size in shaping handwritten data. For example, for shaping handwritten data (handwritten characters) through conversion into character codes, the shaping unit 21 may use the same font size and may align characters at predetermined positions (left alignment, for example). Alternatively, for example, for shaping handwritten data (a handwritten graphic) through conversion into vector data and image data, the shaping unit 21 may use the same graphic object (vector data and image data) size and may align the data at predetermined positions (centering, for example).

The shaping unit 21 may also assign a combination of lines to a stroke that is not matched in pattern matching and convert the stroke into the assigned combination of lines.

Alternatively, the shaping unit 21 may reduce sampling points (coordinate values) of a stroke to such a degree that the shape of the stroke does not change and perform pattern matching thereon. Alternatively, the shaping unit 21 may perform pattern matching by making a stroke approximate to a curve by using a technique such as a Bezier curve and an n-dimensional (N≧1) spline that can be approximation of a curve using some control points.

The display controller 23 displays multiple divided shaping results into which a result of shaping handwritten data is divided on the display unit 25, or displays some of the multiple divided shaping results whose shaping mode is received by the receiving unit 15, which will be described later, as shaping results in the received shaping mode on the display unit 25. Specifically, the display controller 23 displays a result of shaping or a result of re-shaping, which will be described later, each of multiple structures obtained through division by the dividing unit 17 by the shaping unit 21 on the display unit 25, or displays handwritten data acquired by the acquiring unit 13 and linearly supplemented with coordinate values of strokes of the handwritten data on the display unit 25. Although it is assumed in the embodiment that the display unit 25 is realized with the same touch panel as the input unit 11, the display unit 25 is not limited thereto and may be realized with a touch panel different from that of the input unit 11 or with a liquid crystal display or the like.

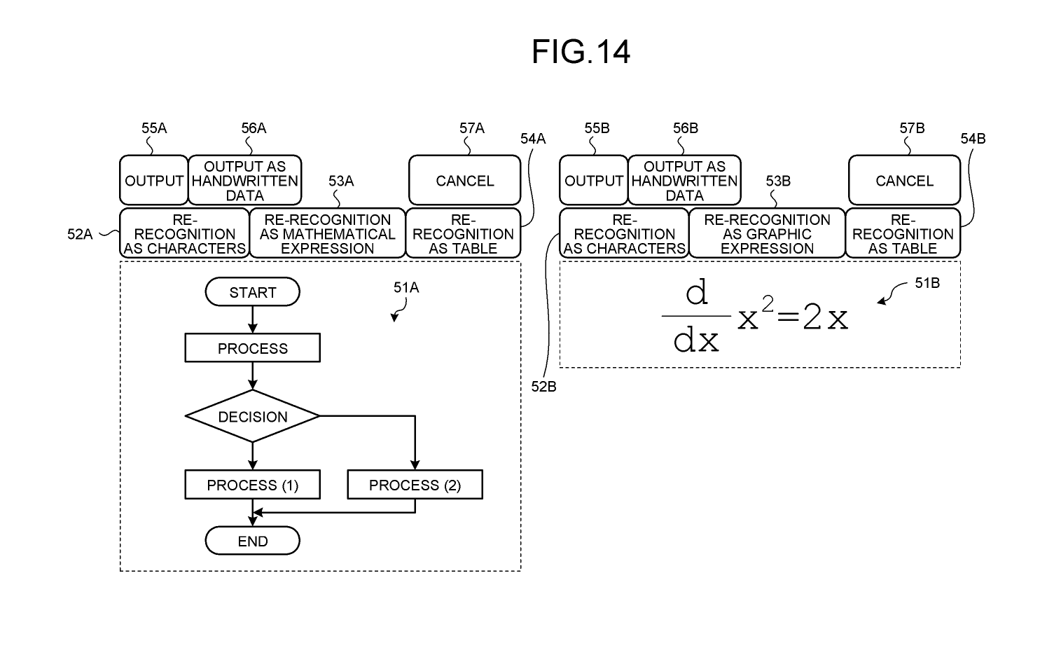

FIG. 14 is a diagram illustrating an example of display of a shaping result according to the embodiment. In the example illustrated in FIG. 14, the flowchart 51A (see FIG. 4) that is a result of shaping the structure 41A (see FIG. 3) is displayed together with a character re-shaping button 52A, a mathematical expression re-shaping button 53A, a table re-shaping button 54A, an output button 55A, a handwriting output button 56A, and a cancellation button 57A, and the mathematical expression 51B (see FIG. 5) that is a result of shaping the structure 41B (see FIG. 3) is displayed together with a character re-shaping button 52B, a graphic re-shaping button 53B, a table re-shaping button 54B, an output button 55B, a handwriting output button 56B, and a cancellation button 57B. Note that the format in which a menu screen such as the character re-shaping button 52A is displayed is not limited thereto, but various display formats such as icons or texts may be employed.

Here, the receiving unit 15 receives an input of a shaping mode for at least one of the multiple divided shaping results displayed on the display unit 25. Specifically, the receiving unit 15 receives an input of the shaping mode of at least one of the multiple structures obtained through the division by the dividing unit 17.

For example, if the character re-shaping button 52A is touched in the example illustrated in FIG. 14, the input unit 11 inputs an instruction to re-shape the structure 41A in the character shaping mode, and the receiving unit 15 receives the re-shaping instruction. Alternatively, for example, if the mathematical expression re-shaping button 53A is touched in the example illustrated in FIG. 14, the input unit 11 inputs an instruction to re-shape the structure 41A in the mathematical expression shaping mode, and the receiving unit 15 receives the re-shaping instruction. Alternatively, for example, if the table re-shaping button 54A is touched in the example illustrated in FIG. 14, the input unit 11 inputs an instruction to re-shape the structure 41A in the table shaping mode, and the receiving unit 15 receives the re-shaping instruction.

Alternatively, for example, if the character re-shaping button 52B is touched in the example illustrated in FIG. 14, the input unit 11 inputs an instruction to re-shape the structure 41B in the character shaping mode, and the receiving unit 15 receives the re-shaping instruction. Alternatively, for example, if the graphic re-shaping button 53B is touched in the example illustrated in FIG. 14, the input unit 11 inputs an instruction to re-shape the structure 41B in the graphic shaping mode, and the receiving unit 15 receives the re-shaping instruction. Alternatively, for example, if the table re-shaping button 54B is touched in the example illustrated in FIG. 14, the input unit 11 inputs an instruction to re-shape the structure 41B in the table shaping mode, and the receiving unit 15 receives the re-shaping instruction.

In these cases, the shaping unit 21 re-shapes the structure received by the receiving unit 15 in the received shaping mode, and the display controller 23 displays the result of re-shaping by the shaping unit 21 on the display unit 25. Since re-shaping is performed by using the shaping techniques described above with reference to the shaping unit 21, detailed description thereof will not be repeated. Although re-shaping in a shaping mode different from the previous shaping mode is assumed in the description, re-shaping may be performed in the same shaping mode as the previous shaping mode. In this case, a button such as “redo” may be displayed, and the receiving unit 15 may receive an input of the same shaping mode as the previous shaping mode. A re-shaping button for the same shaping mode as the previous shaping mode such as a graphic re-shaping button for the flowchart 51A and a mathematical expression re-shaping button for the mathematical expression 51B may further be displayed, and the receiving unit 15 may receive an input of the same shaping mode as the previous shaping mode.

As a result, it is possible to correct a shaping mode erroneously determined by the determining unit 19 or to address a case where the shaping mode determined by the determining unit 19 is correct but shaping in a different shaping mode is desired by the user on purpose.

For example, it can be assumed that the shaping mode for the structure 41B (see FIG. 3) is determined to be a character shaping mode instead of the mathematical expression shaping mode by the determining unit 19, but even in such a case, the incorrect shaping mode can be corrected by inputting an instruction for re-shaping in the mathematical shaping mode.

Alternatively, for example, there may be a case where the graphic shaping mode determined by the determining unit 19 is normally a correct shaping mode since the structure 41A (see FIG. 3) is a handwritten graphic but characters in the flowchart is required according to the intention of the user. Even in such a case, the shaping mode can be changed to that intended by the user by inputting an instruction for re-shaping in the character shaping mode.

The receiving unit 15 also receives an instruction to output at least one of results of shaping and results of re-shaping each of multiple structures obtained through the division by the dividing unit 17 by the shaping unit 21.

For example, if the output button 55A is touched in the example illustrated in FIG. 14, the input unit 11 inputs an instruction to output the flowchart 51A (see FIG. 4) that is a shaping result, and the receiving unit 15 receives the output instruction. Alternatively, for example, if the output button 55B is touched in the example illustrated in FIG. 14, the input unit 11 inputs an instruction to output the mathematical expression 51B (see FIG. 5) that is a shaping result, and the receiving unit 15 receives the output instruction. If the output button 55A or the output button 55B is touched in a state in which a re-shaping result is displayed on the display unit 25, the receiving unit 15 receives an instruction to output the re-shaping result.

In response to the output instruction received by the receiving unit 15, the output unit 27 outputs a corresponding shaping result or re-shaping result in the form of a file, and stores the file of the shaping result or re-shaping result in a storage unit or an external device (such as a cloud) that is not illustrated. Note that the shaping result or re-shaping result may be put into the form of a file by the shaping unit 21 or by the output unit 27.

The receiving unit 15 also receives a handwriting output instruction that is an instruction to output at least one of multiple structures obtained through the division by the dividing unit 17.

For example, if the handwriting output button 56A is touched in the example illustrated in FIG. 14, the input unit 11 inputs a handwriting output instruction for the structure 41A (see FIG. 3), and the receiving unit 15 receives the handwriting output instruction. Alternatively, for example, if the handwriting output button 56B is touched in the example illustrated in FIG. 14, the input unit 11 inputs a handwriting output instruction for the structure 41B (see FIG. 3), and the receiving unit 15 receives the handwriting output instruction.

In response to the handwriting output instruction received by the receiving unit 15, the output unit 27 outputs a corresponding structure in the form of a file, and stores the file of the structure in a storage unit or an external device (such as a cloud) that is not illustrated. Note that the structure may be put into the form of a file by the dividing unit 17 or by the output unit 27.

The receiving unit 15 also receives an instruction to cancel output of a result of shaping or re-shaping each of multiple structures obtained through the division by the dividing unit 17 by the shaping unit 21.

For example, if the cancellation button 57A is touched in the example illustrated in FIG. 14, the input unit 11 inputs an instruction to cancel the flowchart 51A (see FIG. 4) that is a shaping result, and the receiving unit 15 receives the cancellation instruction. Alternatively, for example, if the cancellation button 57B is touched in the example illustrated in FIG. 14, the input unit 11 inputs an instruction to cancel the mathematical expression 51B (see FIG. 5) that is a shaping result, and the receiving unit 15 receives the cancellation instruction. If the cancellation button 57A or the cancellation button 57B is touched in a state in which a re-shaping result is displayed on the display unit 25, the receiving unit 15 receives an instruction to cancel the re-shaping result.

In response to the cancellation instruction received by the receiving unit 15, the output unit 27 cancels output of a file of a shaping result or a re-shaping result or may delete the file if the shaping result or the re-shaping result is already put into the form of a file.

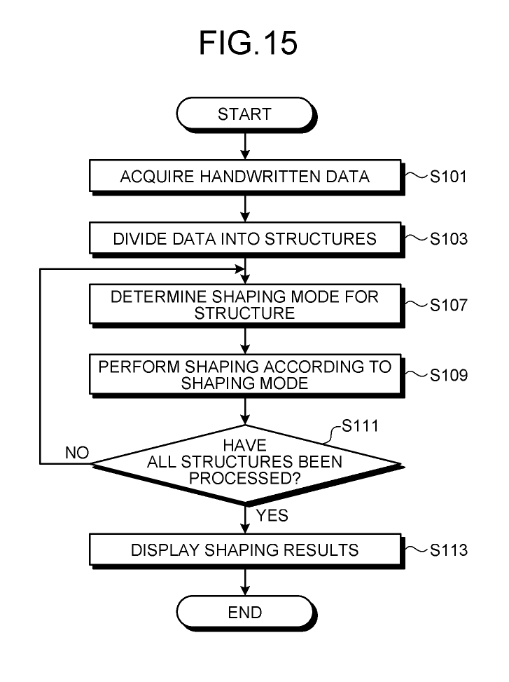

FIG. 15 is a flowchart illustrating an example of a flow of procedures of a shaping process performed in the shaping device 10 according to the embodiment.

First, the acquiring unit 13 acquires handwritten data input by the input unit 11 (step S101).

Subsequently, the dividing unit 17 divides the handwritten data acquired by the acquiring unit 13 into multiple structures (step S103).

Subsequently, the determining unit 19 determines a shaping mode for each of the structures obtained through the division by the dividing unit 17 (step S107).

Subsequently, the shaping unit 21 shapes each of the structures obtained through the division by the dividing unit 17 in the shaping mode determined by the determining unit 19 (step S109).

Steps 5107 to 5109 are then repeated until all the structures obtained through the division by the dividing unit 17 are processed (shaped) (No in step S111).

Subsequently, when all the structures obtained through the division by the dividing unit 17 have been processed (Yes in step S111), the display controller 23 displays the results of shaping the multiple structures obtained through the division by the dividing unit 17 by the shaping unit 21 on the display unit 25 (step S113).

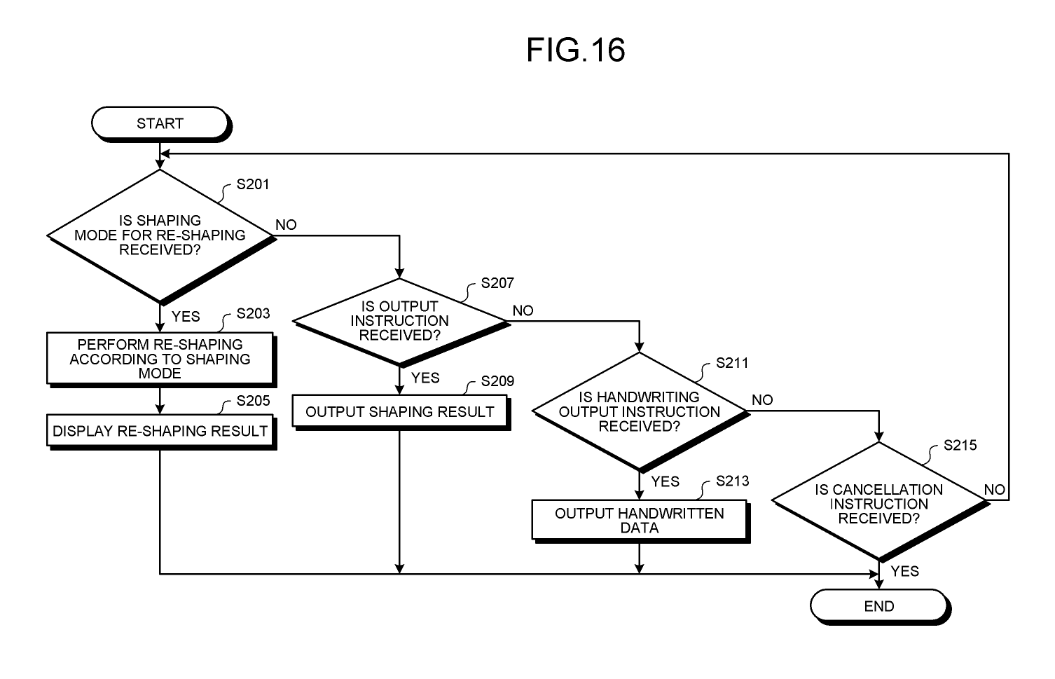

FIG. 16 is a flowchart illustrating an example of a flow of procedures of a re-shaping and output process performed in the shaping device 10 according to the embodiment.

First, when the receiving unit 15 receives a re-shaping instruction instructing a shaping mode for re-shaping at least one of the multiple structures obtained through the division by the dividing unit 17 (Yes in step S201), the shaping unit 21 re-shapes the instructed structure in the instructed shaping mode (step S203), and the display controller 23 displays the result of re-shaping by the shaping unit 21 on the display unit 25 (step S205).

Subsequently, when the receiving unit 15 receives an instruction to output at least one of results of shaping and results of re-shaping the multiple structures obtained through the division by the dividing unit 17 by the shaping unit 21 (No in step 5201 and Yes in step S207), the output unit 27 outputs a file of a corresponding shaping result or re-shaping result (step S209).

Subsequently, when the receiving unit 15 receives a handwriting output instruction for at least one of the multiple structures obtained through the division by the dividing unit 17 (No in step 5207 and Yes in step S211), the output unit 27 outputs a file of a corresponding structure (step S213).

Subsequently, when the receiving unit 15 receives an instruction to cancel output of results of shaping and results of re-shaping the multiple structures obtained through the division by the dividing unit 17 by the shaping unit 21 (No in step 5211 and Yes in step S215), the output unit 27 cancels output of a file of a corresponding shaping result or re-shaping result and terminates the process.

If the receiving unit 15 does not receive a cancellation instruction (No in step S215), the process returns to step S201).

As described above, according to the embodiment, handwritten data is divided into multiple structures and shaping is performed on each of the structures obtained by the division. Thus, according to the embodiment, even handwritten data containing a combination of multiple types of data can be properly shaped.

### Modification 1

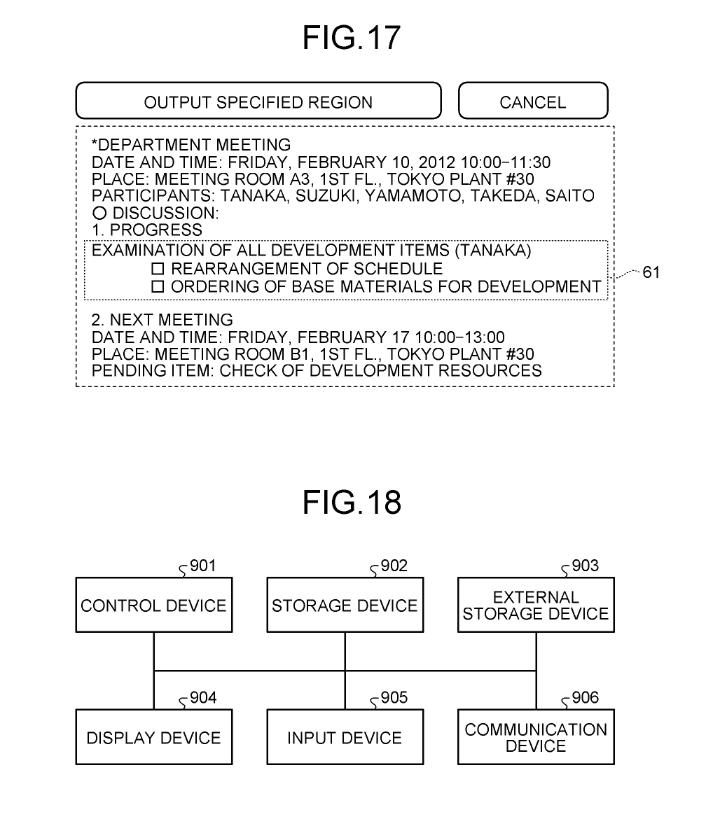

In the embodiment described above, part of a shaping result or a re-shaping result may be specified and output in the form of a file. In this case, the receiving unit 15 may further receive selection (for example, selection of a rectangle 61 illustrated in FIG. 17) of at least part of a shaping result or a re-shaping result together with the output instruction. When the output instruction and the selection are received by the receiving unit 15, the output unit 27 may then output corresponding part of the shaping result or re-shaping result in the form of a file. In this manner, it is possible to output a file of a part required by the user.

### Modification 2

In the embodiment described above, part of a structure may be specified and shaped or re-shaped. In this case, the receiving unit 15 may further receive selection of at least part of a structure together with a shaping instruction or may further receive selection of at least part of a shaping result together with a re-shaping instruction. When a shaping instruction is received by the receiving unit 15, the shaping unit 21 may shape the corresponding part of the structure, or when a re-shaping instruction is received by the receiving unit 15, the shaping unit 21 may re-shape the corresponding part of the shaping result. In this manner, it is possible to shape a part required by the user.

### Modification 3

While handwritten data containing at least two of handwritten characters, handwritten graphics, handwritten tables, and handwritten mathematical expressions is assumed in the description of the embodiment, the contents of handwritten data are not limited thereto and handwritten data can be shaped even if a handwritten calendar, a handwritten to-do list, and the like are contained, for example, by performing shaping (recognition) suitable therefor.

### Modification 4

In the embodiment described above, the character shaping mode may be subdivided according to the language types (for example, a Japanese shaping mode, an English shaping mode, etc.).

### Modification 5

While examples in which re-recognition and output are performed on each structure are described in the embodiment described above, re-recognition and output may be performed on all the structures at a time.

Hardware Configuration

FIG. 18 is a diagram illustrating an example of a hardware configuration of the shaping device 10 according to the embodiment and the modifications. The shaping device 10 according to the embodiment and the modifications described above includes a control device 901 such as a CPU, a storage device 902 such as a ROM and a RAM, an external storage device 903 such as an HDD, a display device 904 such as a touch panel, an input device 905 such as a touch panel, and a communication device 906 such as a communication interface, which is a hardware configuration utilizing a common computer system.

Programs to be executed by the shaping device 10 according to the embodiment and the modifications described above are recorded on a computer readable recording medium such as a CD-ROM, a CD-R, a memory card, a digital versatile disk (DVD) and a flexible disk (FD) in a form of a file that can be installed or executed, and provided therefrom.

Alternatively, the programs to be executed by the shaping device 10 according to the embodiment and the modifications described above may be stored on a computer system connected to a network such as the Internet, and provided by being downloaded via the network. Still alternatively, the shaping device 10 according to the embodiment and the modifications described above may be provided or distributed through a network such as the Internet. Still alternatively, the programs to be executed by the shaping device 10 according to the embodiment and the modifications described above may be embedded in a ROM or the like in advance and provided therefrom.

The programs to be executed by the shaping device 10 according to the embodiment and the modifications described above have modular structures for implementing the components described above on a computer system. In an actual hardware configuration, the CPU reads programs from the HDD and executes the programs on the RAM, whereby the respective components described above are implemented on a computer system.

For example, the order in which the steps in the flowcharts in the embodiments described above are performed may be changed, a plurality of steps may be performed at the same time or the order in which the steps are performed may be changed each time the steps are performed to the extent that the changes are not inconsistent with the nature thereof.

As described above, according to the embodiment and modifications, even handwritten data containing a combination of multiple types of data can be properly shaped.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A shaping device comprising:
one or more processors, the one or more processors configured to:
acquire data handwritten by a user;
divide the data into a plurality of structures;
determine a shaping mode for each of the plurality of structures;
shape the plurality of structures in the shaping mode determined for each of the plurality of the structures; and
a display configured to display a result of shaping each of the plurality of structures.

2. The device according to claim 1, further comprising a first receiving unit configured to receive a shaping mode for at least one of the plurality of structures, wherein
the one or more processors are further configured to re-shape at least one of the plurality of the structure in the received shaping mode, and
the display is configured to display a result of re-shaping the structure.

3. The device according to claim 2, wherein
the first receiving unit is further configured to receive selection of at least part of the structure, and
the one or more processors are further configured to re-shape the selected part of the structure in the received shaping mode.

4. The device according to claim 1, further comprising an output unit configured to output at least one of the results of shaping the plurality of structures in a form of a file.

5. The device according to claim 4, further comprising a second receiving unit configured to receive an instruction to output the shaping result, wherein
the output unit is configured to output the results of shaping the plurality of the structures in a form of a file in response to the instruction received.

6. The device according to claim 5, wherein
the second receiving unit is further configured to receive selection of at least part of the shaping result, and
the output unit is configured to output the selected part of the shaping result in response to the output instruction received.

7. The device according to claim 5, wherein
the second receiving unit is further configured to receive an instruction to cancel output of the shaping result, and
the output unit is configured to cancel output of the shaping result in a form of a file in response to the cancellation instruction received.

8. A shaping method comprising:
acquiring data handwritten by a user;
dividing the data into a plurality of structures;
determining a shaping mode for each of the plurality of structures;
shaping the plurality of structures in the shaping mode determined for each of the plurality of the structure; and
displaying a result of shaping each of the plurality of structures.

9. A shaping device comprising:
an acquiring unit configured to acquire data handwritten by a user;
a display controller configured to display a plurality of results of shaping into which a result of shaping the data is divided on a display; and
a first receiving unit configured to receive a shaping mode for at least one of the plurality of shaping results, wherein
the display controller is configured to display the results of shaping in the received shaping mode on the display.
